(19) United States
(12) Patent Application Publication
(10) Pub. No.: US 2023/0011583 A1
(43) Pub. Date: Jan. 12, 2023

(54) APPARATUS AND METHOD FOR SPH-BASED FLUID ANALYSIS SIMULATION

(71) Applicant: E8IGHT CO., LTD, Seoul (KR)

(72) Inventor: Kwang Joon CHO, Gyeonggi-do (KR)

(21) Appl. No.: 17/784,885

(22) PCT Filed: Dec. 27, 2019
(86) PCT No.: PCT/KR2019/018577

§ 371 Date: Jun. 13, 2022

(30) Foreign Application Priority Data
Dec. 13, 2019 (KR) 10-2019-0166603

(51) Int. Cl. G06F 30/28; G06F 17/11

(52) U.S. Cl. CPC G06F 30/28; G06F 17/11; G06F 2111/10

(57) ABSTRACT

A fluid analysis simulation apparatus based on smoothed particle hydrodynamics (SPH) comprises a structure model generation unit that generates a structure model, a polyhedron generation unit that generates a polyhedron model surrounding the structure model and including a plurality of faces, a particle generation unit that generates a plurality of particles and arranges the plurality of particles inside the structure model using the structure model and the polyhedron model, and a flow data calculation unit that calculates flow data of the plurality of particles and performs a fluid analysis simulation based on the flow data.

### TECHNICAL FIELD

The present disclosure relates to apparatus and method for SPH-based fluid analysis simulation.

### BACKGROUND

Computational fluid dynamics (CFD) is a branch of fluid mechanics that uses computers to numerically calculate a dynamic flow of a fluid. CFD calculates the flow of a fluid by discretizing the Navier-Stokes equation, which is partial differential equation, through finite difference method (FDM), fnite volume method (FVM), smoothed particle hydrodynamics (SPH) and the like.

There are two methods for calculating the Navier-Stokes equation: a grid-based method that discretizes a spatial domain into a small mesh or grid; and a particle-based method that expresses a fluid as a set of particles.

In the particle-based method, a more natural simulation of a natural or physical phenomenon is can be created by expressing an analysis target as particles instead of as a grid. Examples of particle-based methods include smoothed particle hydrodynamics (SPH), moving particle semi-implicit (MPS), lattice Boltzmann method (LBM) and the like.

In a fluid analysis based on smoothed particle hydrodynamics (SPH), which is one of the particle-based methods, unlike the grid-based method, grid generation is omitted, and, thus, the result of analysis can be simulated relatively quickly.

Also, since the SPH-based fluid analysis uses particles without generating a grid, a free surface such as liquid-gas interfaces can be analyzed relatively easily.

Further, a multiphase flow of two or more of gas, liquid and solid can be analyzed relatively accurately by the SPH-based fluid analysis.

Recently, due to these advantages, SPH has been widely used in simulating the flow of a fluid.

According to the particle-based method, a simulation area is modeled and a plurality of initial particles is placed in the simulation area to perform a simulation.

In this case, in order to place the initial particles in the simulation area, it is necessary to set a boundary condition. In particular, when the initial particles are placed in the simulation area, whether or not the initial particles are located inside the simulation area needs to be determined.

To this end, in a conventional method, whether or not a point is within an arbitrary closed polygon is determined based on whether the number of intersections with a line segment is an odd number or an even number when a line is drawn from a specific point in one direction. This method can be applied not only in a two-dimensional space but also in a three-dimensional space. However, when an intersection is at an end point of a line segment in a three-dimensional space, it is quite complicated to compliment this method.

For another example, in a conventional method, all the angles of respective line segments from one point are added up to determine that the point is inside if the sum equals 360° and the point is outside if the sum equals 0°. In this case, it is necessary to determine signs based on the direction of the line segment. This method does not have any exception, but when applied to a three-dimensional space, it has a problem involving the concepts of angles in three dimensions.

Prior Art Document: Japanese Patent No. 600975

### DISCLOSURE OF THE INVENTION

### Problems to be Solved by the Invention

In view of the foregoing, the present disclosure provides a fluid analysis simulation apparatus and method that can easily determine whether or not initial particles are located inside a simulation area.

However, the problems to be solved by the present disclosure are not limited to the above-described problems. There may be other problems to be solved by the present disclosure.

### Means for Solving the Problems

As a means for solving the problems, according to an aspect of the present disclosure, a fluid analysis simulation apparatus based on smoothed particle hydrodynamics (SPH) comprises a structure model generation unit that generates a structure model, a polyhedron generation unit that generates a polyhedron model surrounding the structure model and including a plurality of faces, a particle generation unit that generates a plurality of particles and arranges the plurality of particles inside the structure model using the structure model and the polyhedron model, and a flow data calculation unit that calculates flow data of the plurality of particles and perform a fluid analysis simulation based on the flow data.

Further, according to another aspect of the present disclosure, a A fluid analysis simulation method based on smoothed particle hydrodynamics (SPH) in a fluid analysis simulation apparatus comprises a process of generating a structure model, a process of generating a polyhedron model surrounding the structure model and including a plurality of faces, a process of generating a plurality of particles and arranging the plurality of particles inside the structure model using the structure model and the polyhedron model, and a process of calculating flow data of the plurality of particles and performing a fluid analysis simulation based on the flow data.

The above-described aspects are provided by way of illustration only and should not be construed as liming the present disclosure. Besides the above-described embodiments, there may be additional embodiments described in the accompanying drawings and the detailed description.

### Effects of the Invention

According to any one of the means for solving the problems of the present disclosure described above, it is possible to provide a fluid analysis simulation apparatus and method that can easily determine whether or not initial particles are located inside a simulation area.

### BRIEF DESCRIPTION OF THE DRAWINGS

FIG. 1 is a block diagram of a fluid analysis simulation apparatus according to an embodiment of the present disclosure.

FIG. 2 illustrates an example of a structure model and a polyhedron model according to an embodiment of the present disclosure.

FIG. 3A and FIG. 3B are provided to explain a process for arranging a plurality of particles inside a structure model according to an embodiment of the present disclosure.

FIG. 4A and FIG. 4B are provided to explain a process for arranging a plurality of particles inside a structure model according to another embodiment of the present disclosure.

FIG. 5A and FIG. 5B are provided to explain a process of performing a fluid analysis simulation according to an embodiment of the present disclosure.

FIG. 6 is a flowchart of an SPH-based fluid analysis simulation method in the fluid analysis simulation apparatus according to an embodiment of the present disclosure.

### BEST MODE FOR CARRYING OUT THE INVENTION

Hereafter, embodiments of the present disclosure will be described in detail with reference to the accompanying drawings so that the present disclosure may be readily implemented by a person with ordinary skill in the art. However, it is to be noted that the present disclosure is not limited to the embodiments but may be embodied in various other ways. In drawings, parts irrelevant to the description are omitted for the simplicity of explanation, and like reference numerals denote like parts through the whole document.

Throughout this document, the term “connected to” may be used to designate a connection or coupling of one element to another element and includes both an element being “directly connected” another element and an element being “electronically connected” to another element via another element. Further, it is to be understood that the terms “comprises,” “includes,” “comprising,” and/or “including” means that one or more other components, steps, operations, and/or elements are not excluded from the described and recited systems, devices, apparatuses, and methods unless context dictates otherwise; and is not intended to preclude the possibility that one or more other components, steps, operations, parts, or combinations thereof may exist or may be added.

Throughout this document, the term “unit” may refer to a unit implemented by hardware, software, and/or a combination thereof. As examples only, one unit may be implemented by two or more pieces of hardware or two or more units may be implemented by one piece of hardware.

Throughout this document, a part of an operation or function described as being carried out by a terminal or device may be implemented or executed by a server connected to the terminal or device. Likewise, a part of an operation or function described as being implemented or executed by a server may be so implemented or executed by a terminal or device connected to the server.

Hereinafter, embodiments of the present disclosure will be explained in detail with reference to the accompanying drawings.

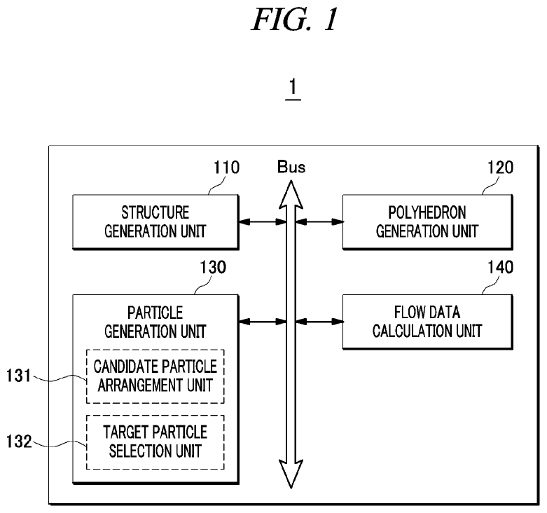

FIG. 1 is a configuration diagram of a fluid analysis simulation apparatus according to an embodiment of the present disclosure. Referring to FIG. 1, a fluid analysis simulation apparatus 1 may include a server, a desktop, a laptop computer, a kiosk, a smartphone and a tablet PC. However, the fluid analysis simulation apparatus 1 is not construed to be limited to these examples. That is, the fluid analysis simulation apparatus 1 may include all devices equipped with a processor for performing an SPH-based fluid analysis simulation method to be described later.

The fluid analysis simulation apparatus 1 performs a 3D flow analysis on a fluid. That is, the fluid analysis simulation apparatus 1 models a 3D simulation area and a plurality of particles located in the 3D simulation area, and analyzes the flow of the plurality of particles in the 3D simulation area. However, in the present disclosure, for the convenience of description, the simulation area and particles are expressed in two dimensions.

The fluid analysis simulation apparatus 1 may perform a simulation for analyzing a fluid based on smoothed particle hydrodynamics (SPH). SPH is one of the particle-based fluid analysis techniques that can be used in computational fluid dynamics (CFD). In order to simulate the movement of a fluid, which is an analysis target, SPH can express the fluid as one or more particles. SPH can calculate a physical quantity of a particle while tracking each particle and perform a fluid analysis simulation based on the result of calculation.

The fluid analysis simulation method according to an embodiment of the present disclosure is a particle-based fluid analysis simulation method and may use, for example, smoothed particle hydrodynamics (SPH).

The fluid analysis simulation method according to the present disclosure is applied to a field where a fluid analysis simulation is calculated in real time, but is not limited thereto. The fluid analysis simulation method according to the present disclosure can also be applied to various application fields requiring a fluid analysis simulation.

Examples of application fields include computer game, medical simulation, scientific application and computer animation.

The fluid analysis simulation apparatus 1 may include a structure generation unit 110, a polyhedron generation unit 120, a particle generation unit 130 and a flow data calculation unit 140.

The structure generation unit 110 may generate a structure model. To this end, for example, the structure generation unit 110 may generate a structure model based on terrain information, structure information, boundary condition information, particle property information, gravitational acceleration information and the like input from a user using a keyboard, a mouse, a joystick, a touch screen, a microphone and the like. Herein, the structure information may include at least one of density, restitution coefficient and friction coefficient. Also, the particle property information may include at least one of particle radius, density, viscosity, speed of sound and initial velocity.

The polyhedron generation unit 120 may generate a polyhedron model surrounding the structure model and including a plurality of faces. Herein, the polyhedron model may be a hexahedron model. For example, the polyhedron generation unit 120 may generate a polyhedron model with six square faces, and may also generate a polyhedron model with six triangular faces.

The particle generation unit 130 may generate a plurality of particles and arrange the plurality of particles inside the structure model using the structure model and the polyhedron model.

The particle generation unit 130 may include a candidate particle arrangement unit 131 and a target particle selection unit 132.

The candidate particle arrangement unit 131 may arrange a plurality of candidate particles inside the polyhedron model.

The particle generation unit 130 may select a plurality of target particles except a plurality of candidate particles 211 located outside the structure model.

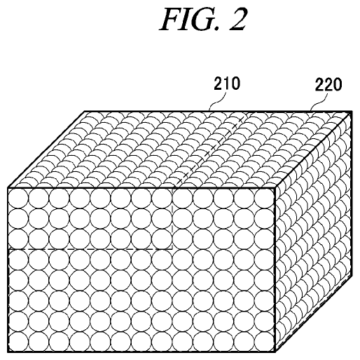

A process for arranging a plurality of particles inside the structure model will be described with reference to FIG. 2.

FIG. 2 illustrates an example of a structure model and a polyhedron model according to an embodiment of the present disclosure. Referring to FIG. 2, the structure generation unit 110 may generate a structure model 200 (blue line), and the polyhedral generation unit 120 may generate a polyhedron model 210 (red line) to surround the structure model 200 (blue line).

The particle generation unit 130 may generate a plurality of particles and arrange the plurality of particles inside the structure model 200. For example, the candidate particle arrangement unit 131 may arrange a plurality of particles as a plurality of candidate particles inside the polyhedron model 210.

Referring back to FIG. 1, the target particle selection unit 132 may project a plurality of faces of the polyhedron model onto the surface of a sphere corresponding to each of the plurality of candidate particles, and select a plurality of target particles based on the areas of the plurality of projected faces.

For example, if the polyhedron model 210 is a hexahedron model composed of triangles, the target particle selection unit 132 may project the triangles onto the surface of a sphere centered on a point in order to determine three vertices of all the triangles. In this case, the projected triangle may be the viewing angle of the polyhedron model at the center of the sphere. Thereafter, the target particle selection unit 132 may add up the areas of all the triangles projected onto the surface of the sphere. In this case, when one of the projected triangles has an opposite rotation direction, the area of the triangle may be excluded.

When the sum of the areas of the plurality of projected faces is equal to the surface area (4 πr²) of the sphere corresponding to a particle, the target particle selection unit 132 may select the corresponding candidate particle as the target particle.

For example, if the polyhedron model is a hexahedron model composed of triangles and the faces of the triangles are projected onto the surface of the sphere, the projected triangles may cover the entire surface of the sphere. In this case, there may be a threefold overlapping area in part. However, when the areas are added up in consideration of signs, + and − cancel out each other and only one sign remains. Thus, the entire surface of the sphere can be covered without overlap. That is, the viewing angle of the polyhedron model from a point of the sphere may be a full viewing angle. In this case, the target particle selection unit 132 may select the corresponding candidate particle as the target particle since the sum of the areas of the plurality of projected faces is 4 πr², which is equal to the surface area of the sphere.

For another example, if a point of the sphere is located outside the polyhedron model, the opposite signs of the projected triangles cancel out each other, and, thus, the sum of the areas may become 0. In this case, the target particle selection unit 132 may not select the corresponding candidate particle as the target particle since the sum of the areas of the plurality of projected faces is 0 and is not equal to the surface area (4 πr²) of the sphere.

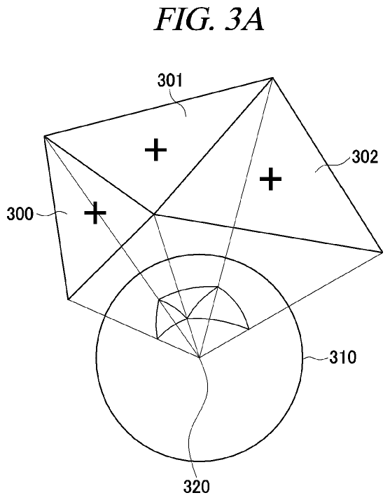

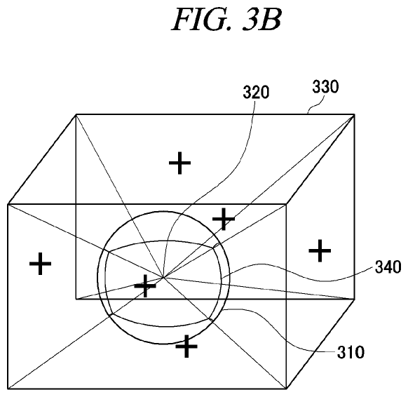

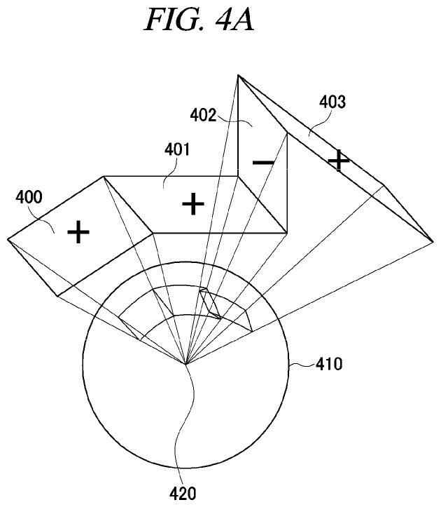

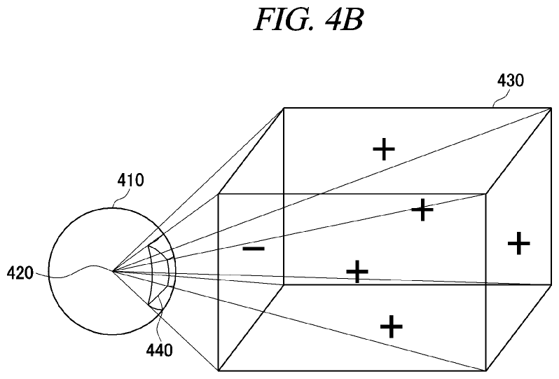

A process for selecting a target particle will be described with reference to FIG. 3A to FIG. 4B.

FIG. 3A and FIG. 3B are provided to explain a process for arranging a plurality of particles inside a structure model according to an embodiment of the present disclosure.

Referring to FIG. 3A, the target particle selection unit 132 may project a plurality of faces 300 to 302 onto the surface of a sphere 310 corresponding to each of a plurality of candidate particles, and select a plurality of target particles based on the areas of the plurality of projected faces 300 to 302.

For example, the target particle selection unit 132 may project each of the plurality of faces 300 to 302 onto the surface of the sphere 310 centered on one point 320, and add up all the areas of the polyhedron projected onto the sphere 310. In this case, it is necessary to determine signs based on the normal directions of the faces.

Referring to FIG. 3B, when the sum of the areas of the plurality of projected faces 300 to 302 is equal to the surface area of the sphere 310, the target particle selection unit 132 may select the corresponding candidate particle as the target particle.

For example, if the point 320 of the sphere 310 exists inside a polyhedron 330, when all faces of the polyhedron 330 are projected onto the sphere 310, the area of a projected face 340 may be 4 πr² with which the entire surface of the sphere 310 can be completely covered.

In this case, since the area of the projected face 340 is equal to the surface area of the sphere 310, the target particle selection unit 132 may select the corresponding candidate particle as the target particle.

FIG. 4A and FIG. 4B are provided to explain a process for arranging a plurality of particles inside a structure model according to another embodiment of the present disclosure.

Referring to FIG. 4A, the target particle selection unit 132 may project a plurality of faces 400 to 403 onto the surface of a sphere 410 corresponding to each of a plurality of candidate particles, and select a plurality of target particles based on the areas of the plurality of projected faces 400 to 403.

For example, the target particle selection unit 132 may project each of the plurality of faces 400 to 403 onto the surface of the sphere 410 centered on one point 420, and add up all the areas of the polyhedron projected onto the sphere 410. In this case, a “−” sign may be included based on the normal directions of the faces.

Referring to FIG. 4B, when the sum of the areas of the plurality of projected faces is not equal to the surface area of the sphere 410, the target particle selection unit 132 may not select the corresponding candidate particle as the target particle.

For example, if the point 420 of the sphere 410 exists outside a polyhedron 430, when all faces of the polyhedron 430 are projected onto the sphere 410, the signs of the projected faces cancel out each other, and, thus, the area of a projected face 440 on the surface of the sphere 410 may be “0”.

In this case, since the area of the projected face 440 is not equal to the surface area (4 πr²) of the sphere 410, the target particle selection unit 132 may not select the corresponding candidate particle as the target particle.

Referring back to FIG. 1, the flow data calculation unit 140 may calculate flow data of the plurality of particles and perform a fluid analysis simulation based on the flow data.

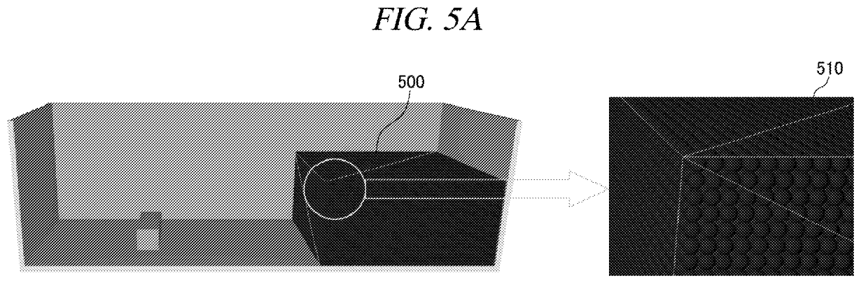

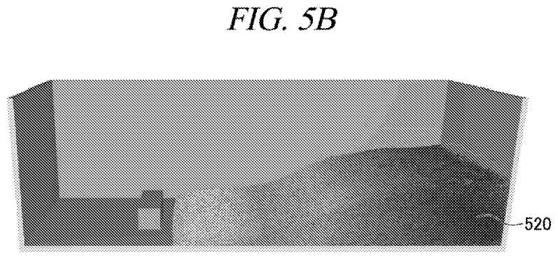

A process for performing a fluid analysis simulation will be described with reference to FIG. 5A and FIG. 5B.

FIG. 5A and FIG. 5B are provided to explain a process of performing a fluid analysis simulation according to an embodiment of the present disclosure.

Referring to FIG. 5A, in the particle-based method, initial particles 510 may be arranged at regular intervals inside a structure model 500 within a three-dimensional space through the process of determining whether or not a point exists inside an arbitrary polyhedron based on FIG. 1 to FIG. 4B.

Referring to FIG. 5B, the flow data calculation unit 140 may calculate flow data of a plurality of particles when the arrangement of the initial particles inside the structure model 500 is completed.

The flow data calculation unit 140 may calculate flow data of a plurality of particles with respect to the structure model 500 based on an SPH algorithm. For example, the flow data calculation unit 140 may calculate the flow data of the plurality of particles with respect to the structure model 500 after removing a plurality of particles located outside a polyhedron model and the structure model 500.

Specifically, the flow data calculation unit 140 may use the SPH algorithm to calculate flow data caused by collisions between each particle and neighboring particles or collisions between each particle and polygons constituting a structure model, and may perform a fluid analysis simulation based on the flow data.

The SPH algorithm calculates the flow of each particle by using physical property information (e.g., mass, velocity, viscosity and acceleration) of each particle, and the physical property information of each particle is interpolated by using a set of kernel functions such as a radial basis function centered at the position of each particle.

Interpolating the physical property information of each particle as described above generates continuous fields such as a pressure field and a viscosity field that can be used to calculate the dynamics of the fluid using standard equations such as the Navier-Stokes equation.

For example, the Navier-Stokes equation models the fluid as follows.

$$ρ ( ( \frac{\partial ν}{\partial t} ) + v \cdot ∇ v ) = ρ g - ∇ p + μ {∇}^{2} v \qquad [ Equation 1 ]$$

In Equation 1, “v” denotes a velocity of a particle, “p” denotes a density of the particle, “p” denotes a pressure on the particle, “g” denotes gravity and “μ” denotes a viscosity coefficient of the fluid.

Meanwhile, according to the SPH algorithm, the density of each particle is derived by Equation 2.

$$ρ ( {x}_{i} ) = {\sum }_{j} {m}_{j} W ( {x}_{i} - {x}_{j} , h ) \qquad [ Equation 2 ]$$

Also, the pressure force on each particle is derived by Equation 3.

$${f}_{i}^{pressure} = - {\sum }_{j} {m}_{j} \frac{{p}_{i} + {p}_{j}}{2 {ρ}_{j}} ∇ W ( {x}_{i} - {x}_{j} , h ) \qquad Equation 3 ]$$

Further, the viscosity force of each particle is derived by Equation 4.

$${f}_{i}^{viscosity} = μ {\sum }_{j} {m}_{j} \frac{{v}_{j} - {v}_{i}}{{ρ}_{j}} {∇}^{2} W ( {x}_{i} - {x}_{j} , h ) \qquad [ Equation 4 ]$$

The flow data calculation unit 140 calculates changes in flow data such as density, pressure and viscosity of each particle by using the SPH algorithm. For example, the flow data calculation unit 140 calculates flow data of each particle in a next time step (first time step) based on initial flow data of each particle, and calculates the flow of each particle based on the calculated flow data.

Then, the flow data calculation unit 140 calculates flow data of each particle in a next time step based on the flow data of each particle in the first time step, and calculates the flow of each particle based on the calculated flow data.

The flow data calculation unit 140 may perform the fluid analysis simulation by calculating the flow data of each particle in each time step and calculating the flow of each particle.

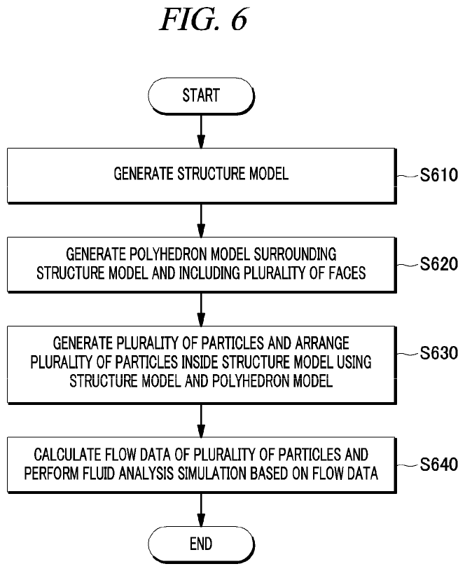

FIG. 6 is a flowchart of a fluid analysis simulation method according to an embodiment of the present disclosure. A fluid analysis simulation method 600 to be performed by the apparatus 1 illustrated in FIG. 6 includes the processes time-sequentially performed by the apparatus 1 according to the embodiment illustrated in FIG. 1. Therefore, the descriptions of the processes may also be applied to the fluid analysis simulation method to be performed by the apparatus 100 according to the embodiment illustrated in FIGS. 1 to 5B even though they are omitted hereinafter.

In a process S610, the fluid analysis simulation apparatus 1 may generate a structure model.

In a process S620, the fluid analysis simulation apparatus 1 may generate a polyhedron model surrounding the structure model and including a plurality of faces.

In a process S630, the fluid analysis and simulation apparatus 1 may generate a plurality of particles and arrange the plurality of particles inside the structure model using the structure model and the polyhedron model.

In a process S640, the fluid analysis simulation apparatus 1 may calculate flow data of the plurality of particles and perform a fluid analysis simulation based on the flow data.

In the descriptions above, the processes S610 to S640 may be divided into additional processes or combined into fewer processes depending on an embodiment. In addition, some of the processes may be omitted and the sequence of the processes may be changed if necessary.

The method for performing fluid analysis simulation on basis of SPH by the fluid analysis simulation apparatus described above with reference to FIG. 6 can be implemented in a computer program stored in a medium to be executed by a computer or a storage medium including instructions codes executable by a computer. A computer-readable medium may include computer storage medium. The computer storage medium includes all volatile/non-volatile and removable/non-removable media embodied by a certain method or technology for storing information such as computer-readable instruction code, a data structure, a program module or other data.

The above description of the present disclosure is provided for the purpose of illustration, and it would be understood by those skilled in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

1. A fluid analysis simulation apparatus based on smoothed particle hydrodynamics (SPH), comprising:
a structure model generation unit that generates a structure model;
a polyhedron generation unit that generates a polyhedron model surrounding the structure model and including a plurality of faces;
a particle generation unit that generates a plurality of particles and arranges the plurality of particles inside the structure model using the structure model and the polyhedron model; and
a flow data calculation unit that calculates flow data of the plurality of particles and performs a fluid analysis simulation based on the flow data.

2. The fluid analysis simulation apparatus of claim 1,
wherein the particle generation unit includes a candidate particle arrangement unit that arranges a plurality of candidate particles inside the polyhedron model, and
the particle generation unit selects a plurality of target particles except a plurality of candidate particles located outside the structure model.

3. The fluid analysis simulation apparatus of claim 2,
wherein the particle generation unit further includes a target particle selection unit that projects the plurality of faces onto a surface of a sphere corresponding to each of the plurality of candidate particles, and selects the plurality of target particles based on areas of the plurality of projected faces.

4. The fluid analysis simulation apparatus of claim 3,
wherein when the sum of the areas of the plurality of projected faces is equal to surface area of the sphere, the target particle selection unit selects the corresponding candidate particle as the target particle.

5. The fluid analysis simulation apparatus of claim 1,
wherein the polyhedron model is a hexahedron model.

6. A fluid analysis simulation method based on smoothed particle hydrodynamics (SPH) in a fluid analysis simulation apparatus, comprising:
generating a structure model;
generating a polyhedron model surrounding the structure model and including a plurality of faces;
generating a plurality of particles and arranging the plurality of particles inside the structure model using the structure model and the polyhedron model; and
calculating flow data of the plurality of particles and performing a fluid analysis simulation based on the flow data.

7. The fluid analysis simulation method of claim 6,
wherein the arranging the plurality of particles inside the structure model includes:
arranging a plurality of candidate particles inside the polyhedron model; and
selecting a plurality of target particles except a plurality of candidate particles located outside the structure model.

8. The fluid analysis simulation method of claim 7,
wherein the arranging the plurality of particles inside the structure model further includes:
projecting the plurality of faces onto surface of a sphere corresponding to each of the plurality of candidate particles; and
selecting the plurality of target particles based on areas of the plurality of projected faces.

9. The fluid analysis simulation method of claim 8,
wherein the selecting the plurality of target particles includes:
when the sum of the areas of the plurality of projected faces is equal to surface area of the sphere, selecting the corresponding candidate particle as the target particle.

10. The fluid analysis simulation method of claim 6,
wherein the polyhedron model is a hexahedron model.

11. A computer-readable storage medium that stores a program configured to cause a computing device to perform a method of claim 10.
